(19) United States
(12) Patent Application Publication
(10) Pub. No.: US 2007/0035255 A1
(43) Pub. Date: Feb. 15, 2007

(54) LED strobe for hazard protection systems

(76) Inventors: James Shuster, Tecumseh, MI (US); Paul Strelecki, Whitehouse Station, NJ (US); Janis Shuster, Tecumseh, MI (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/407,792

(22) Filed: Apr. 20, 2006

Related U.S. Application Data
(60) Provisional application No. 60/706,644, filed on Aug. 9, 2005.

(51) Int. Cl. H05B 37/00; H05B 39/00

(52) U.S. Cl. 315/200 R

(57) ABSTRACT

A light-emitting diode (“LED”) based strobe may be used in automated system to provide a visual alert to occupants and/or building personnel if an emergency condition exists. A LED based strobe provides an even distribution of light having a sharp, bright pulse of light desired for emergency evacuation using lower power consumption.

### CROSS-REFERENCE TO RELATED APPLICATIONS

This application claims the benefit of U.S. Provisional Patent Application Ser. No. 60/706,644, filed Aug. 9, 2005, which is incorporated in its entirety herein by reference.

### BACKGROUND

The present invention relates to automated protection systems, and particularly to solid state visual alerts for fire and security systems.

Automated building systems monitor and maintain safety and habitability of a building. For example, fire safety and security systems may include multiple components distributed throughout a building to monitor the building environments. Components of a fire safety system may detect a hazard by monitoring an environment of a building for fire, smoke and other by-products of combustion. When a hazard is detected, other components may be triggered to provide visual and audible alerts. The alerts may notify building occupants, building management, and emergency personnel of the detected hazard.

Components of a security system include devices and networks for surveillance of an environment and controlling access to a building or portions thereof. The components of a security system include alarm equipment, notification networks, and other building security-related equipment. Automated systems also may integrate multiple building control functions including heating, ventilation and air conditioning (“HVAC”), lighting, air quality control, industrial control and other automated control equipment. Examples of fire alarm systems include the FireFinder XLS®, MXL, NCC, systems available from Siemens Building Technologies, Inc. of Florham Park, N.J.

Standards and specifications for fire safety system define performance parameters for the components of the first safety systems. Installation specifications may require a visual alert to occupants of a building in response to a detected hazard condition. For example, a fire protection system may have a strobe light located in a corridor or room. The strobe light flashes at a specified frequency or within a certain frequency range when the system detects fire, smoke, CO, CO₂ or other by-products of combustion. The intensity and dispersion of light from a strobe may be required to meet specified parameters and safety standards. Current strobes use discharge bulbs, such as a Xenon discharge bulb, to provide the strobed illumination or alert. The discharge bulbs require sophisticated power and control circuitry for synchronizing and controlling the illumination. Operation of the discharge bulbs may be sensitive to fluctuations in power and may have a relatively short life requiring periodic monitoring and testing for proper operation.

Therefore, there is a need for a strobe for fire protection systems that provide long operating life, consume less power and provide requisite light intensities for a visual alert.

### BRIEF SUMMARY

The described embodiments include methods, processes, apparatuses, and systems to provide a visual alert in response to a detected hazard using solid state light strobe. The visual alert may be provided to occupants of a building in response to detecting a fire, smoke, or other by-product of combustion.

The visual alert may be a strobe that includes one ore more solid state light sources such as a light emitting diode (“LED”), an organic light emitting diode (“OLED”) or other solid state light sources. The light sources may be aligned about a circumference of a disk to form a “light ring.” Light from the light ring may spread over a 180-degree coverage area from the strobe. Multiple light rings may be stacked to produce additional intensity or tune the light emission to other desired photometric output characteristics. The solid state light sources may be arranged in an array configuration for inherent redundancy so that in the event of a failure of one or more sources, the remaining sources will continue to operate.

The solid state sources may be housed in an enclosure that includes other components. The enclosure provides mechanical and electrical protection for the components and may have external mounting points or a mounting flange for installation of the enclosure, and strobe, in a building. The enclosure and mounting arrangement may be configured for ease of replacement of an existing alert for a protection system such as an existing flashing light, rotating beacon, or xenon strobe, without the need to modify the structure. The enclosure also may be configured to protect the solid-state sources and internal components from the environmental elements such as water. For example, the enclosure may have a protective, water-resistant or water-proof lens.

A power source supplies power for the solid state light sources. The power supply may be modulated to control the illumination of the light sources. Voltage and current levels may be controlled to a level compatible with the light source. The power source and/or control circuit may be housed within the enclosure, or may be remotely located. The control circuit regulates timing of the sources and provides sufficient electrical power to activate the light source and preventing over-driving of the sources. The control circuit also may provide temperature compensation for stabilized light intensity with variations in ambient temperature. The control circuit also may be configured to control the light sources for testing such as self-diagnostic testing. For example, the control circuit may monitor the strobe light for fault conditions. If a fault condition is detected, an electrical signal may be generated and provided to the protection system. Fault notification may also be provided by altering output characteristics to attract an operator's attention, such as altering the flash rate. The light sources may be controlled to emit a dimmed light in a constant-on mode or in a flashing pattern to facilitate visual inspection of the LED strobe light for failed LED elements or to transmit status and diagnostic data.

The present invention is defined by the following claims. Nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 shows a block diagram of an exemplary arrangement for an automated building system incorporating solid state visual alerts.

FIG. 2 illustrates an example of a strobe for an automated building system having solid state light sources.

FIG. 3 illustrates a schematic diagram for an example of a solid state strobe for an automated building system.

### DETAILED DESCRIPTION

The present invention relates to a strobe having one or more solid state light sources (“Light Sources”). The strobe may be used as an alert for a building automation system, such as a fire safety and security system. The strobe may include one more light sources such as light emitting diodes (LED's) or organic light emitting diodes (OLED's) arranged to illuminate at a periodic rate in accordance with building safety standards. The light sources may provide white light or substantially white light illumination with a forward illuminating flux with a luminous intensity of 15 candelas and more. The light sources may be arranged in any of a variety of patterns to provide a desired emission pattern. For example, the light sources may be in a disk or about the circumference of the disk to form a “light ring” having 180-degree coverage for light emission. Light rings may be stacked if desired in order to produce the desired photometric output characteristics. In another example, the light sources are arranged in an array or aligned in one or more rows and/or columns. The light sources may be configured for inherent redundancy to provide substantially continuous illumination characteristics when one or more light sources of an array fails to continue to operate.

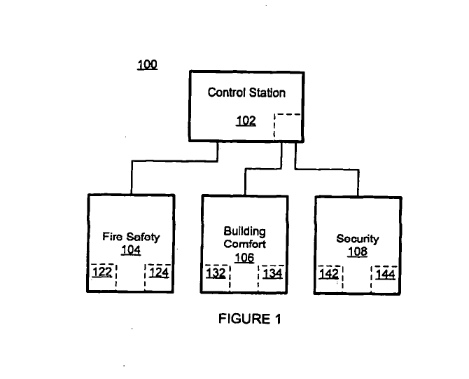

FIG. 1 shows a block diagram of an exemplary building automation system 100. The building automation system 100 includes multiple components such as sensors and detectors for monitoring and reporting conditions and events in an environment, such as the environment for a building or facility. The building automation system may also include component that may be triggered or operated in response to a control or actuation signal. The control or actuation signal may be generated in response to the detection of an event or condition by one of the sensor and/or detectors. For example, the building automation system 100 may include devices that generate and obtain alarm and other event information and other component that operate in response to alarm and other event information.

The building automation system 100 may include one or more individual or task specific systems that together form an integrated building automation system 100. In the example of FIG. 1, the building automation system 100 includes a control station 102, a fire safety system 104, a building comfort or environment control system 106, and a security system 108. The systems 104, 106 and 108 may operate individually or together to form an integrated building automation system 100. The systems may communicate or report status and control information with the central control station 102. Examples of a building comfort system include the APOGEE®) system available from Siemens Building Technologies, Inc., and an example of a fire safety system includes the FireFinder XLS® system available from Siemens Building Technologies, Inc. The system may be a security system.

The fire safety system 104 is an integrated system that includes a multiple fire—system devices 122, 124. The fire safety devices perform any of a number of fire safety system functions, including smoke detection, fire detection, audible and visible notification alarms and alerts, local control and communication, and other now known or later developed fire safety functions. The fire safety devices 122 and 124 may report event messages to a control panel of the fire safety system 104 which may in turn communicate event messages to the control station 102 over one or more communication networks. An event message may include information regarding a non-normal condition such as information related to detected fire conditions of combustion by-products, communication problems, equipment trouble, or other information that indicates that equipment within the fire safety system 104 requires action or further review.

The building comfort system 106 is an integrated Heating, Ventilation and Air Conditioning system. The building comfort system 106 includes multiple devices 132 and 134 that perform any of building environmental system functions. Building system devices 132 and 134 may include, for example, temperature sensors, heating and/or cooling valves, actuators ventilation dampers and actuators, chiller plants, control and communication devices, and any other devices used in HVAC systems of different sizes. The building automation system 106 monitors and controls temperature, air quality and other comfort or environment factors. The building system devices 132 and 134 may report alarm or other event messages to the control station 102, which may trigger one or more visual and audible alerts. For example, a device 132 may detect a temperature rise in a portion of the build and report the rise to a control panel of the building comfort system 106. The control panel may communicate the temperature rise to the control station 102. The event messages may relate to out of boundary conditions, communication problems, equipment trouble, or other non-normal conditions. An event message may indicate that equipment within the building automation system 106 may require action or further review. For example, an excessive temperature rise may be determined to be the result of a hazard condition, in response to which the control station 102 and/or the building comfort system 106 may trigger or operate visual and audible alerts.

The security system 108 is an integrated system that includes one or more building security devices 142 and 144. The security devices 142 and 144 perform building security functions. Examples of building security devices 142 and 144 include, motion and proximity sensors, video monitors, key-coded entry devices, glass breakage detectors, heat detectors, visual and audible alarms, control and communication devices, and other devices used in security systems. The security system devices 142 and 144 may communicate alarm and other event messages to the control station 102. For example, a device 142 may detect an intrusion in a portion of the building, and report the intrusion to a control panel of the security system 108. The control panel may communicate the detected intrusion to the control station 102. The event messages may relate to detection of movement, compromise of a door lock, actuation of a manual alarm device, communication problems, equipment trouble, or other non-normal conditions. An event message typically indicates that equipment within the one or more of systems 104,106, 108 may require action or further review. For example, the detected intrusion may be determined to be the result of a alarm condition, in response to which the control station 102 and/or the security system 108 may trigger or operate visual and audible alerts.

The control station 102 provides a centralized monitoring, supervising and control of various subsystems and/or components. The general supervisory control and monitoring functions may vary from system to system. Such functions, within the framework of a fire safety system 104, a building comfort system 106 and a security system 108 are known. The control station 102 may be any processor, controller, application specific integrated circuit or general purpose computer. The control station 102 may include a processing circuit, communications interface, one or more input devices and output devices and data storage devices for carrying out functions and features of building automation. The control station 102 also may include other devices, such as modems, disk arrays, printers, scanners and other devices. Examples of individual workstations 102 for each of the systems 104, 106 and 108 include the INSIGHT® Workstation available from Siemens Building Technologies, Inc.

The control station 102 may request data from individual systems 104,106 and 108 and elements and/or component thereof. The data may be processed and displayed for user feedback, monitoring, and control. By way of example, temperature measurements from a temperature sensor, or operational status information from a smoke sensor or motion sensor may be displayed. The processing circuit obtains the data from the relevant system 104, 106 and 108 via a communication interface and then displays the information on a display such as a video monitor. The control station 102 may perform specific commands to one or more elements of the systems 104, 106 and 108, such as a change to a parameter of operation of a particular ventilation damper, or of a chiller plant. The control station 102 may also perform automated control operations for any of the systems 104, 106 and 108. The control station 102 may also receive event messages from devices on each of the systems 104, 106 and 108. The control station 102 displays event condition information responsive to the event messages. In addition, the control station 102 may cause other action in the event of certain alarms.

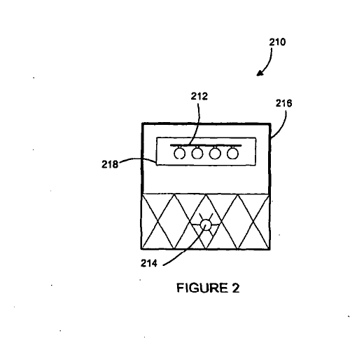

FIG. 2 illustrates an example of a visual alert device, or strobe, 210 that may be used with any, each, or all of the building automation system 100, the fire system 104, the comfort system 106, and/or the security system 108 of FIG. 1. The strobe 210 includes a housing 216 providing an enclosure for a light source 212. The strobe 210 also may include a lens 218 to disperse light from the light source. The strobe 210 may also include an audible alarm 214. The strobe 210 may include additional components and circuitry for operating a visual alert in response to a receiving a trigger signal.

The housing 216 is configured to enclose components of the strobe 210. The housing 216 provides electrical, mechanical, and environmental protection for the components enclosed within the housing 216. The housing 216 may be formed of thermoplastic or thermoset material. The housing 216 includes mounting arrangement, such as a mounting flange. The mounting flange may include openings or slots through which a fastener may be applied for securing the strobe 210 to a structure, such as a wall or ceiling of a building. The housing 216 with the mounting arrangement may be arranged to be secured to a housing of an existing strobe. For example, the housing 216 may permit replacement of an existing visual alert device such as a flashing light, rotating beacon, or xenon strobe without any or substantial modifications to the visual alert device.

The light source 212 illuminates or flashes in a periodic, rhythmic, or random pattern. The light source 212 may operate in response to a trigger signal provided by a power source. For example, the light source may be operated in response to alarm event or condition sensed by a component of any, each, or one of the systems 104, 106, and 108 of a building automation system 100. Timing of the operation of the light source 212 may also be controlled by the power source or a timing circuit. The light source 212 illuminates or radiates light in response to an electrical voltage applied between two or more electrical connections of the light source 212.

In an embodiment, the light source 212 may be one or more solid state light devices that emit light in response to an applied voltage, such as a semiconductor diode or light-emitting diode (“LED”). In an embodiment, the light source 212 is one or more white LED's such as an LED of the DRAGON family of hi-flux LED modules from Osram Sylvania. The light source 212 provide illumination of white light or substantially white light for a wide range of space and over a wide range of applied voltages. The light source 212 may also illuminate over a range of color temperatures for white light, include about 4700K, 5400K and 6500K. The light source 212 also provides a color rendering index (CRI) greater than 80. The light source 212 may be configured to have a luminous intensity of around 285 or more candelas. The light source 212 may have a variable LED intensity according to a light programmable current source. An example of a light source includes a DRAGONtape® and/or a DRAGONpuck® LED module.

The light source 212 may be configured or arranged as multiple LED's aligned in a single column or row. The light source 212 also may be configured as an array of LED's arranged in one or more columns and rows. The LED's may provide a package of bright LED light sources in a flat module. The column and/or array may be affixed to a flexible tape which may be secured in the housing 216.

In an example, the light source 212 includes six or more LEDs electrically connected in series and spaced approximate one inch. The six LEDs may be powered by one constant-current power supply which may be triggered or controlled by a timing circuit to provide a flashing light source at a desired frequency.

In another embodiment the light source 212 may be a puck or disc having multiple LED's arranged about a circumference of the disc. The light source 212 may have an on-board optic to narrow or focus the light for a spot-lighting application. For example, the light source 212 may include three or more hi-flux LEDs affixed to a substrate, such as a metal substrate on a common circuit board.

In another embodiment, the light source 212 may include one or more organic light emitting diodes (“OLEDs”). An example of an OLED light source includes one or more organic layers sandwiched between two electrodes. One of the electrodes is transparent to allow light to pass. Application of a voltage permits charge carriers, such as electrons and/or holes, to be injected into one or more of the organic layers from an opposing electrode. These carriers hop between molecules or polymer segments in the organic layer under the influence of the electric field until they recombine at a luminescent center. As a result, photons emit from the OLED. The OLED may be tuned to provide a desired luminescent characteristic such as color, temperature, and intensity.

An example of an implementation of an OLED may be as described in U.S. patent application Ser. No. 10/671,234, which is incorporated in its entirety by reference herein. The light source 212 and housing 216 may be configured as a woven fabric, textile, or tape or like material. Accordingly, the strobe 210 may be implemented in carpeting, and/or window coverings, moldings, and trim to provide an escape route in a building such as an office or stairwell. The strobe may also be implemented in building hardware such as door handles, door trim, exit ways, stairs, railings, and other building equipment. In an example, the strobe 210 may be implemented in carpeting of a building, and/or the wall coverings for the building, where a fire safety system controls OLEDs of the strobe 210 to direct building occupants to exit ways.

The strobe 210 may also include optics 218 that focuses or disperses light from the light source 212. The optics 218 may be a transparent lens that focuses light from the light source 212 to a desired coverage area. The lens also may protect the light source from mechanical and environmental hazards, such as water from water sprinklers that may be activated in emergency situations.

The strobe 210 may include an audible alarm 214 that is operated in response to a trigger signal. The audible alarm 214 may sound an audible signal to alert occupants of a hazardous condition. The audible alarm 214 may be timed or synchronized to operate with a flashing of the light source 212. The audible alarm 214 may produce an alarm signal substantially simultaneously with a flashing of the light source 212. The alarm signal may be operated at a same or substantially same operating frequency of the light source 212.

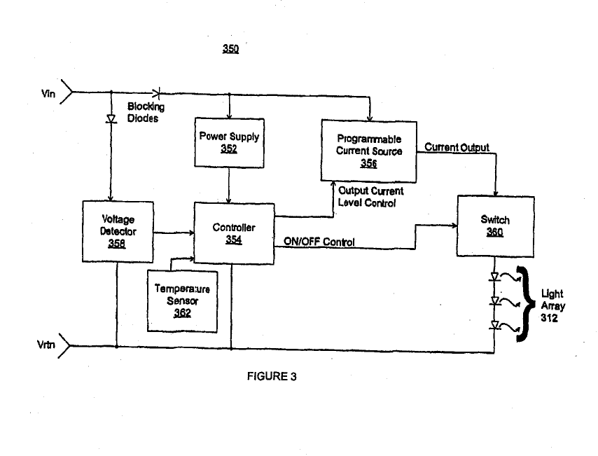

FIG. 3 illustrates an operating circuit 350 for a light source, such as one or more solid state or semiconductor light sources 312. The operating circuit 350 conditions a voltage and current to a level compatible with the light source 312. All or portions of the operating circuit 350 may be enclosed within the housing of a strobe. For example, the operating circuit 350 may be mounted inside the housing 216 of the strobe 210, or may be located remotely. The operating circuit 350 provides electrical power to activate the light source 312. The operating circuit 350 also controls power to the light source 312 to prevent over-driving devices of the light source 312, such as LEDs or OLEDs. The operating circuit 350 also regulates the on-off timing or flashing of the light source 312.

The operating circuit 350 may receive operating power from an automation system, such as the fire safety system 104. For example, electrical power may be supplied by a fire safety system described in U.S. patent application Ser. No. 10/671,234 titled Ethernet-Based Fire System Network which is incorporated in its entirety by reference herein. The operating circuit 350 may be configured to control the light source 312. The light source also or in addition may be controlled by an external control system, such as the control system described in U.S. patent application Ser. No. 10/671,234, which is incorporated in its entirety by reference herein.

The operating circuit 350 receives electrical power (voltage and current) from a power supply such as a constant-current power supply (Vin/Vrtn). For example, the operating circuit may be connected to a DC and/or AC power supply (Vin/Vrtn). In an example, the voltage input may be around 10-31 Vdc. The power may be converted, such as by an AC-DC conversion or DC-DC conversion to control the light source 312. The power supplied (Vin/Vrtn) to the light source 312 may be varied to adjust the intensity of the light source 312 in a range of 100% to 0%.

The operating circuit 350 may include a power supply 352, a controller 354, a line voltage detector 358, a current source 356, and a switch 360. The operating circuit also may include a temperature sensor 362. The input voltage Vin provides power to operate the various components of the operating circuit and the light source 312. The power supply 352 may be a DC-DC and or AC-DC power supply. The power supply 352 is configured to provide nominal power for the controller 354. In an embodiment, the power supply 352 converts power from the input voltage Vin to a voltage suitable to operate the controller 354. For example, the power supply 352 may supply a regulated 5 Volt dc power to the controller.

The voltage detector 358 monitors the voltage level of the input voltage Vin. The voltage detector generates an indicator, such as an analog or digital electrical signal associated with the input voltage Vin level. The temperature sensor 362 may be arranged to generate an analog or digital signal associated with an ambient temperature for the light source 312, the operating circuit 350, and/or the strobe itself.

The controller 354 implements a control process. The control process may be implemented on a signals received by the controller 354, such as signals or the voltage detector 358, temperature sensor 362, and/or derived from data input. The controller 354 may be a general processor, central processing unit, digital signal processor, control processor, microcontroller, application specific integrated circuit, field programmable gate array, programmable logic controller, analog circuit, digital circuit, combinations thereof or other now known or later developed devices for implementing a control process. The controller 354 has a processing power or capability and associated memory corresponding to the needs of the operating circuit and one or more of different types of light sources 312. The controller 354 implements a control process algorithm specific to the operating circuit 350. Other control processes may be stored but unused due to a specific configuration.

The programmable current source 356 provides sufficient current to the light source 312 to provide appropriate illumination for a specified flash period. In an embodiment, the current source is configured to provide a variable regulated current sufficient to control the intensity of the light from the LED's. The amount of current to be provided may be varied within an operating range, such as according to a control signal received from the controller 354. An example of a power source includes the OSRAM OPTOTRONIC® constant current power supply.

The controller generates an On/Off control signal to control the alternating on/off frequency of the light source 312. The on/off frequency may be controlled within any desired range, and particularly within the specifications and guidelines for safety standards. For example, the controller may control the light source to flash within the guidelines established for fire safety strobes. In an embodiment, the controller may control the light source to flash or illuminate between around 20 and around 120 flashes per minute as required by applicable safety standards of National Fire Protection Association (NFPA). The controller 354 also controls programming of the programmable current source via the current control signal. The controller 354 may control the current source to provide a constant current to the light source light source 31 independent of the amount of voltage at the input Vin as read by the voltage detector 358. Similarly, the controller may vary the programmable current source to provide a constant current independent of the ambient temperature reading of the temperature sensor 362.

The switch 360 is operated to apply the current from the current source 356 to the light source 312 in response to the control signal from the controller 354. The switch 360 may be an electrical, mechanical, or electromechanical switching device. In an embodiment, the switch 360 include one or more metal oxide semiconductor field effect transistors configured to block current to the light source in response to an off signal and to provide current in response to an ON signal. The switch 360 also may include energy, or charge, storage devices such as capacitors and/or inductors. The switch 360 may be configured to discharge the energy from energy storage devices to the light source 312 in response to the control signal from the controller 354.

The light source 312 emits light in response to current flow through the light source 312 via the switch 360. The light source 312 may include one or more semiconductor light sources such as LED's and OLED's as described for FIG. 2. The electrical current flows through the light source 312 and is returned to the power supply via the return Vrtn.

The controller may also be configured to allow diagnostic testing and/or self-diagnostic capabilities. The controller may monitor the light source 312 and components of the operating circuit 350 for fault conditions. If a fault is detected, the controller may operate the light source 312 to provide a programmed sequence of flashes. The controller 354 also may communicate an alert to a fire safety system with an electrical output signal back to the fire safety system as described in U.S. patent application Ser. No. 10/671,234, which is incorporated in its entirety by reference herein.

The operating circuit also may allow multiple modes of operation. For example, the controller may be programmed to monitor an input line for a trigger signal, such as a signal that would trigger operation of the light source in response to a detected alert condition. The controller 354 also may include a servicing mode. In a servicing mode, the light source 312 may be operated bench-test diagnostic features. The light source 312 could be operated to dimly illuminate or illuminate a maximum intensity to test performance of the light source 312 or provide visual inspection of the light source 312. A failed component, such as a burned out LED can be detected by visual inspection of the light source 312 without the need for protective eyewear. The controller 354 may control operation light source 312 to display status information and diagnostic data such as with a sequence or coding of flashes of the light source 312. The number and/or sequence of flashes may correspond to pre-programmed diagnostic conditions. The status and diagnostic LEDs could also be used to optically couple serial data, such as fault codes, from the control circuit to a maintenance computer.

Accordingly, it is an object of this invention to provide a strobe light for use in building automation systems such as a fire safety system. The strobe provides long operating life with desired light intensities with a light source that does not require complex timing and charging circuits or high-voltage power supplies.

While the invention has been described above by reference to various embodiments, it should be understood that many changes and modifications can be made without departing from the scope of the invention. The description and illustrations are by way of example only. Many more embodiments and implementations are possible within the scope of this invention and will be apparent to those of ordinary skill in the art. For example, the various embodiments have a wide variety of applications including integrated building control systems, environmental control, security detection, communications, industrial control, power distribution, and hazard reporting. For example, the strobe may be adapted for use with industrial control equipment, environmental quality, other lighting systems and integrated systems including combinations thereof. The strobe may also be used for entertainment systems to provide high frequency strobe lights. The strobe may be used with integrated systems where, for example, an environmental control system may be integrated with a fire detection and prevention system.

It is intended that the appended claims cover such changes and modifications that fall within the spirit, scope and equivalents of the invention. The invention is not to be restricted except in light as necessitated by the accompanying claims and their equivalents. Therefore, the invention is not limited to the specific details, representative embodiments, and illustrated examples in this description.

We claim:

1. A visual alert device, comprising:
a) a solid state light source configured to radiate light in response to a control signal, the light radiating at intensity at least 15 candela; and
b) a controller configured to control the solid state light source to periodically operate in accordance with a signal for activating occupant lighting.

2. The visual alert device of claim 1 where the solid state light source comprises at least one light emitting diode (LED).

3. The visual alert device of claim 2 where the solid state light source comprises a plurality of LED's arranged about a circumference of a disc to radiate light to a substantially common area.

4. The visual alert device of claim 3 comprising a plurality of discs each having a plurality of LED arranged about the circumference of the corresponding disc, each of the LED's configured to radiate light to a substantially common area.

5. The visual alert device of claim 1 where the solid state light source comprises at least one organic light emitting diode (OLED).

6. The visual alert device of claim 5 where the visual alert device comprises a building hardware device.

7. The visual alert device of claim 1 where the controller comprises a programmable current source configured to control a constant current provided to the light source.

8. The visual alert device of claim 1 where the controller comprises a programmable current source configured to control a constant current provided to the light source according to an environmental condition of the visual alert device.

9. The visual alert device of claim 8 where the environmental condition comprises an ambient temperature proximate to the visual alert device.

10. The visual alert device of claim 8 where the controller comprises a processor to control the programmable current source.

11. The visual alert device of claim 1 where the light source is controlled to have a flash rate in the range of about 20 to about 120 flashes per minute.

12. The visual alert device of claim 1 where the controller is configured to operate the light source in any of a plurality of modes.

13. The visual alert device of claim 12 where the plurality of modes comprises a diagnostic mode.

14. An automated building system, comprising:
a) a plurality of building automation devices;
b) a central controller configured to receive information from the plurality of automation devices, the information related to environmental conditions for a building; and
c) at least one solid state light strobe configured to radiate a visual alert signal in response to an alert signal received from the central controller, the solid state light strobe including at least one hi-flux semiconductor device that emits light to a portion of a structure in a periodic flashing pattern, having an intensity and dispersion pattern in accordance with a recognized safety standard.

15. The building automation system of claim 14 where the plurality of building automation devices are configured to monitor fire hazards.

16. The building automation system of claim 14, where the solid state light strobe comprises a plurality of hi-flux light emitting diodes (LED's).

17. The building automation system of claim 14, where the solid state light strobe comprises a plurality of hi-flux organic light emitting diodes (OLED's).

18. A method for providing a visual alert to occupants of a building, comprising:
monitoring a building environment for a hazard; and
providing a visual alert using a solid state visual alert device in response to detecting a hazard condition, the visual alert including light being radiated from a semiconductor device at with an intensity in accordance with a recognized safety standard associated with the detected hazard.

19. The method of claim 18 further comprising:
monitoring the building environment for by-products of combustion; and
providing the visual alert using the solid state visual alert device in response to detecting a by-product of combustion.

20. The method of claim 18 where the semiconductor device comprises a plurality of light emitting diodes.
